(19) United States
(12) Patent Application Publication
(10) Pub. No.: US 2026/0036150 A1
(43) Pub. Date: Feb. 5, 2026

(54) LOCK STRUCTURE

(71) Applicant: Yazaki Corporation, Tokyo (JP)

(72) Inventors: Hiroyuki KATO, Kakegawa-shi (JP); Shinichi YANAGIHARA, Kakegawa-shi (JP); Taichi MURAMATSU, Fujieda-shi (JP)

(73) Assignee: Yazaki Corporation, Tokyo (JP)

(21) Appl. No.: 19/282,439

(22) Filed: Jul. 28, 2025

(30) Foreign Application Priority Data
Aug. 5, 2024 (JP) 2024-128887

(51) Int. Cl. F16B 2/22; H02G 3/04

(52) U.S. Cl. CPC F16B 2/22; H02G 3/0456

(57) ABSTRACT

A lock structure includes: an engagement protrusion that protrudes from an outer surface of a side wall portion of a first member; a cantilevered flexible engagement frame that is provided on a side end of a second member fixed to the first member and extends along the outer surface of the side wall portion to engage with the engagement protrusion; an engagement piece that protrudes from a tip of the side wall portion; and an engagement piece engaging portion that is provided between base portions on an inner surface of the flexible engagement frame to abut against the tip of the side wall portion, and includes a restriction surface abutting against an inner surface of an engagement piece and configured to prevent rattling of the flexible engagement frame.

### CROSS-REFERENCE TO RELATED APPLICATION(S)

This application is based upon and claims the benefit of priority from prior Japanese patent application No. 2024-128887 filed on Aug. 5, 2024, the entire contents of which are incorporated herein by reference.

### BACKGROUND

### 1. Field of the Invention

The present disclosure relates to a lock structure.

### 2. Description of the Related Art

In the related art, a conductive member that is connected to a power supply such as a battery and supplies electricity to an electrical component or the like has been used in a power supply circuit or the like. Some conductive members of this type include a strip-shaped flat conductor (busbar) having a predetermined width.

Such a conductive member needs to ensure electrical insulation of the flat conductor. For example, a technique of covering a flat conductor with an insulating material and a technique of insulating a flat conductor with a protector made of an insulating resin are well-known.

In addition, an assembled component including a box-shaped or trough-shaped case body such as an electric junction box or a protector and a cover that covers an opening of the case body has a lock structure for fixing the cover to the case body (see JP2013-178969A, JP2019-57459A and JP2024-29413A).

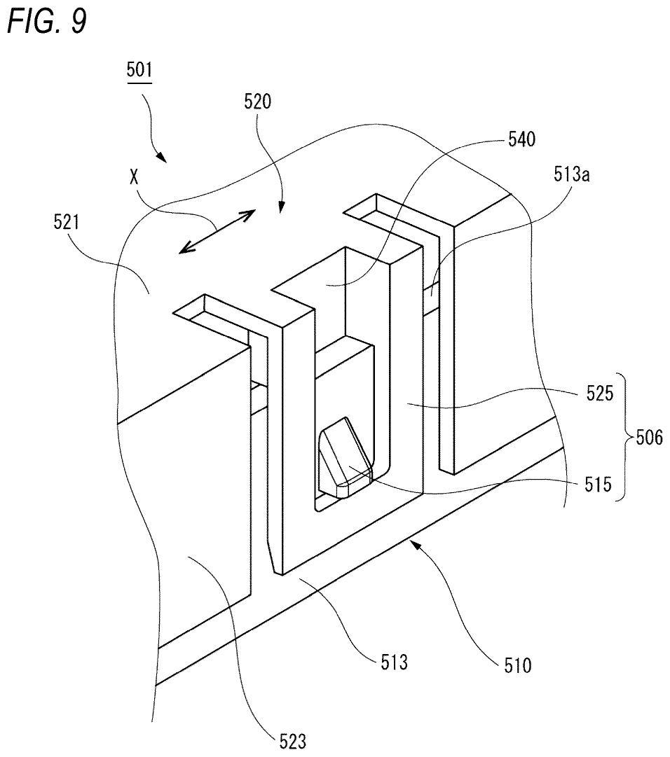

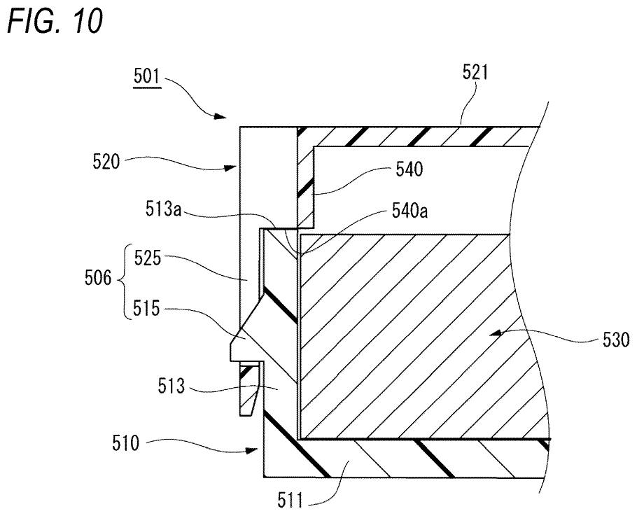

For example, as shown in FIGS. 9 and 10, a conductive member 501 includes a strip-shaped flat conductor (busbar) 530, and a case body 510 and a cover 520 that are disposed to face front and back surfaces of the flat conductor 530 and cover the flat conductor 530 from a plate thickness direction.

The case body 510 includes a bottom wall portion 511 formed in a substantially rectangular shape in a plan view, and two side wall portions 513 vertically provided on two side edges in a width direction of the bottom wall portion 511, and houses an intermediate portion of the flat conductor 530. Further, engagement protrusions 515 protrude from outer surfaces of the two side wall portions 513.

The cover 520 is mounted in such a manner of covering an upper opening side of the case body 510 with the flat conductor 530 interposed therebetween, and covers the flat conductor 530. The cover 520 has an upper wall portion 521 having substantially the same shape as an outer shape of the cover 520 in the plan view, and two side wall portions 523 hanging down from two side edges of the upper wall portion 521. Further, at the two side edges of the upper wall portion 521, cantilevered flexible engagement frames 525 extending along outer surfaces of the side wall portions 513 are provided to engage with the engagement protrusions 515.

In addition, a positioning portion 540 that abuts against a tip 513a of the side wall portion 513 to position the cover 520 with respect to the case body 510 is provided between base portions on an inner surface side of the flexible engagement frame 525.

When the cover 520 is attached to the case body 510, as shown in FIG. 10, an abutting portion 540a of the positioning portion 540 abuts against the tip 513a of the side wall portion 513 and is positioned, and the flexible engagement frame 525 is engaged with and locked to the engagement protrusion 515. That is, a lock structure 506 for fixing the cover 520 to the case body 510 is implemented by the engagement protrusion 515 and the flexible engagement frame 525.

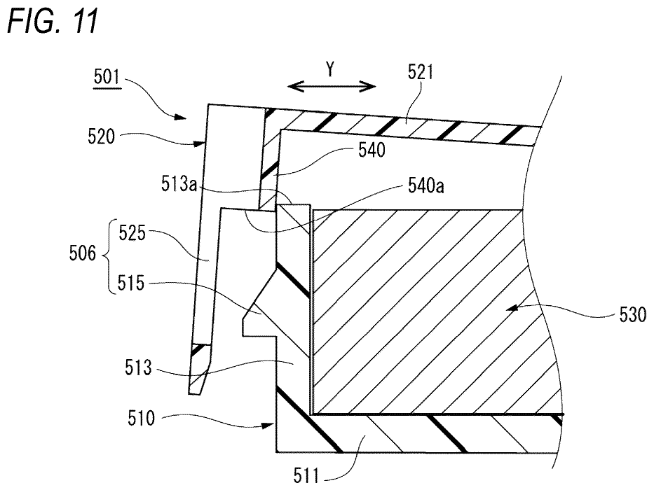

However, in the lock structure 506 described above, as shown in FIG. 11, when the cover 520 rattles along a width direction Y while the flexible engagement frame 525 is engaged with and locked to the engagement protrusion 515, the engagement lock may be released. That is, since the above lock structure 506 does not have a structure for preventing the rattling, the cover 520 may rattle along the width direction Y or may be displaced along a longitudinal direction X with respect to the case body 510.

### BRIEF DESCRIPTION OF THE DRAWINGS

The present disclosure has been made in view of the above circumstances, and an object thereof is to provide a lock structure capable of preventing inadvertent unlocking.

According to an aspect of the present disclosure, there is provided a lock structure including: an engagement protrusion that protrudes from an outer surface of a side wall portion of a first member; a cantilevered flexible engagement frame that is provided on a side end of a second member fixed to the first member and extends along the outer surface of the side wall portion to engage with the engagement protrusion; an engagement piece that protrudes from a tip of the side wall portion; and an engagement piece engaging portion that is provided between base portions on an inner surface of the flexible engagement frame to abut against the tip of the side wall portion, and includes a restriction surface abutting against an inner surface of an engagement piece and configured to prevent rattling of the flexible engagement frame.

According to the lock structure of the present disclosure, inadvertent unlocking can be prevented.

The present disclosure is briefly described above. Further, details of the present disclosure can be clarified by reading a mode (hereinafter, referred to as an “embodiment”) for carrying out the invention to be described below with reference to the accompanying drawings.

### BRIEF DESCRIPTION OF THE DRAWINGS

The present disclosure will become more fully understood from the detailed description given hereinbelow and the accompanying drawing which is given by way of illustration only, and thus is not limitative of the present disclosure and wherein:

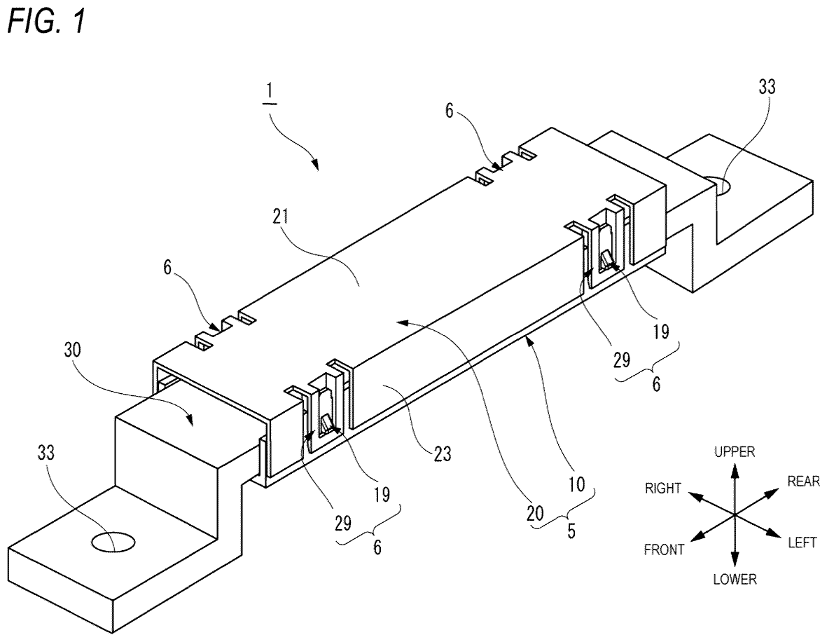

FIG. 1 is a perspective view of a conductive member having a lock structure according to an embodiment of the present disclosure;

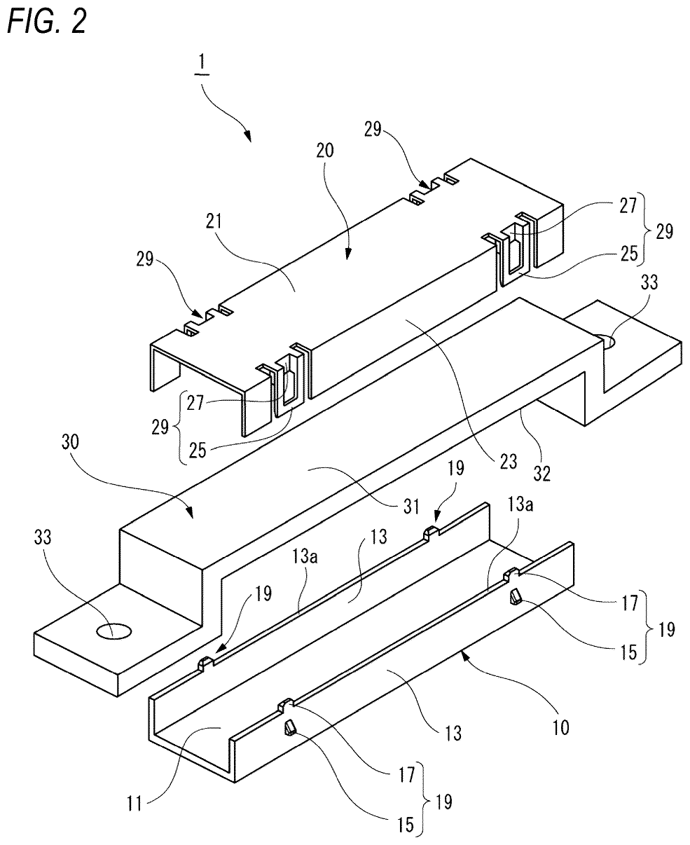

FIG. 2 is an exploded perspective view of the conductive member shown in FIG. 1;

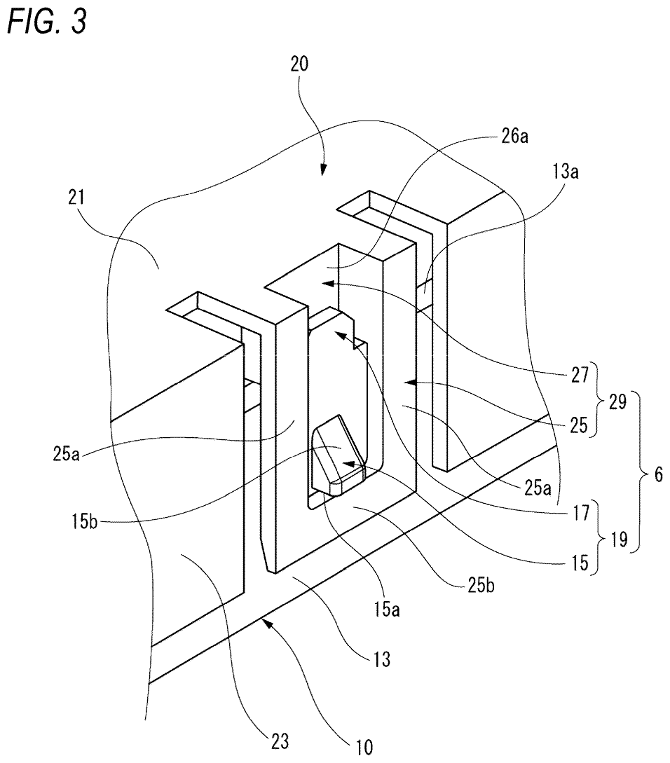

FIG. 3 is an enlarged perspective view of the lock structure shown in FIG. 1;

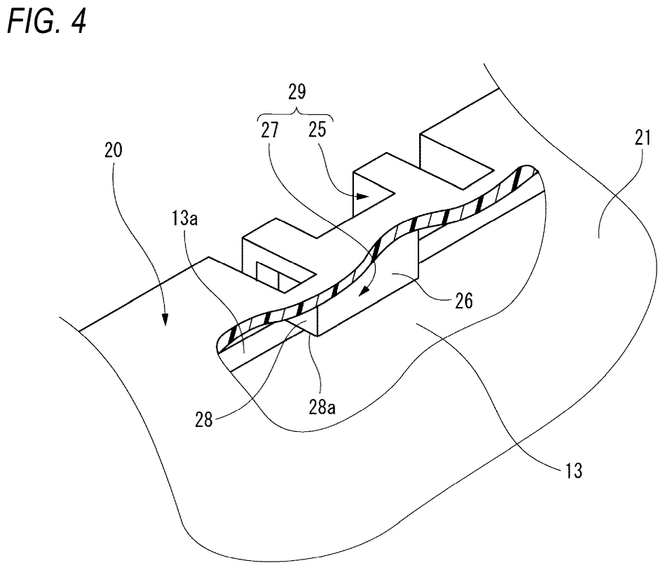

FIG. 4 is a partially cutaway perspective view of the lock structure shown in FIG. 3 as viewed from an inner surface side;

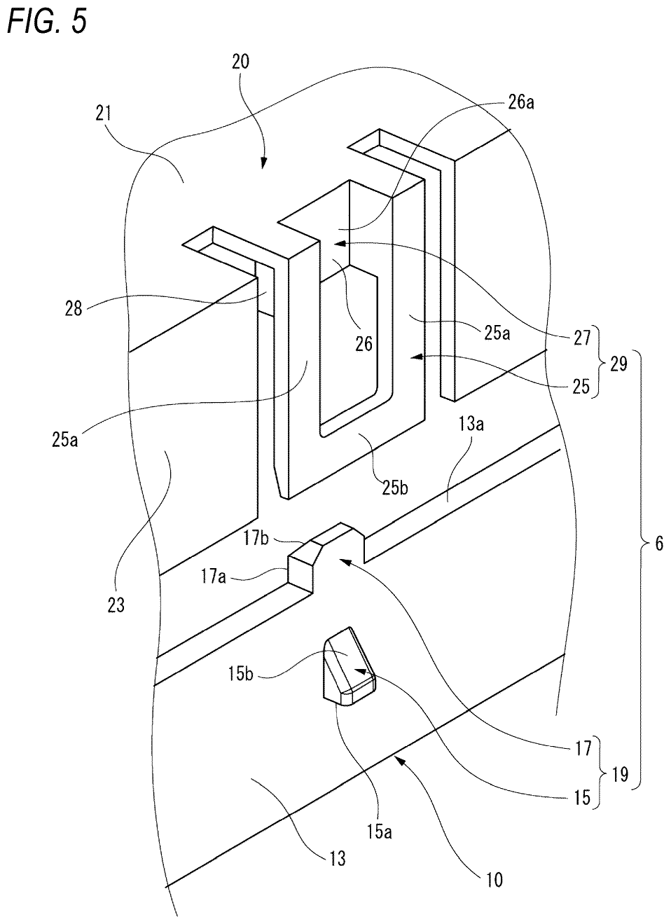

FIG. 5 is a perspective view showing a release state of the lock structure shown in FIG. 3;

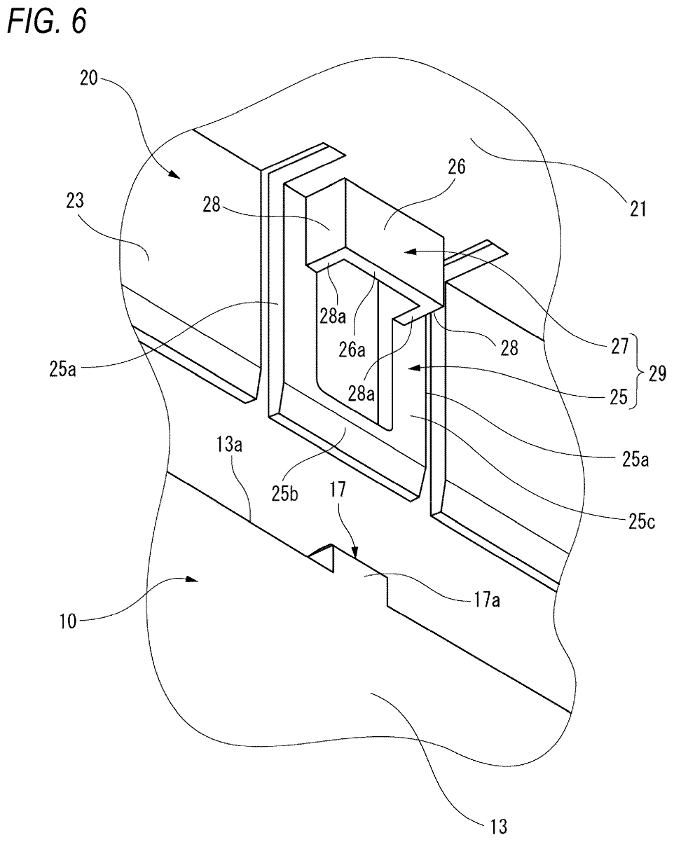

FIG. 6 is a perspective view of the lock structure shown in FIG. 5 as viewed from the inner surface side;

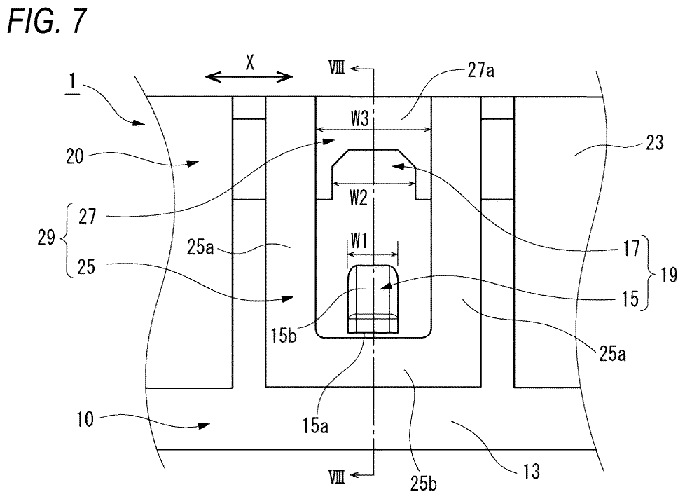

FIG. 7 is a front view of the lock structure shown in FIG. 3;

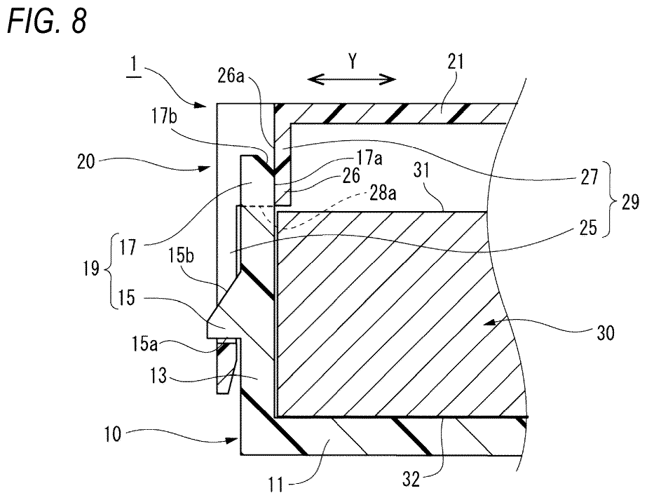

FIG. 8 is a sectional view taken along a line VIII-VIII of FIG. 7;

FIG. 9 is an enlarged perspective view showing a lock structure in the related art;

FIG. 10 is a sectional view of the lock structure in the related art shown in FIG. 9; and

FIG. 11 is a sectional view showing a state where engagement lock of the lock structure shown in FIG. 10 is released.

### DETAILED DESCRIPTION OF THE INVENTION

Hereinafter, embodiments of the present disclosure will be described with reference to the drawings.

A conductive member 1 including a lock structure 6 according to the present embodiment is, for example, an inter-stack wiring module used for electrical connection between a plurality of battery stacks. Needless to say, the lock structure 6 of the present disclosure is not limited to a protector 5 used in the conductive member 1 of the present embodiment, and is not limited to an assembled component including a box-shaped or trough-shaped case body such as an electric junction box or a wire harness protector and a cover covering an opening of the case body, but can be applied to various assembled components including a first member and a second member fixed to the first member.

FIG. 1 is a perspective view of the conductive member 1 including the lock structure 6 according to the embodiment of the present disclosure. FIG. 2 is an exploded perspective view of the conductive member 1 shown in FIG. 1. In the present embodiment, upper-lower, front-rear, and left-right directions in the conductive member 1 follow upper-lower, front-rear, and left-right directions indicated by arrows shown in FIG. 1.

As shown in FIGS. 1 and 2, the conductive member 1 according to the present embodiment includes, as main components, a strip-shaped flat conductor (busbar) 30, a case body (first member) 10 that houses an intermediate portion of the flat conductor 30, and a cover (second member) 20 that is attached to the case body 10 to cover an upper opening of the case body 10 to hold the flat conductor 30. The case body 10 and the cover 20 integrally molded by injection molding or the like constitute a protector 5 made of an insulating resin, and are integrally held by a plurality of (four in the present embodiment) lock structures 6.

As shown in FIG. 2, the flat conductor 30 is formed of a conductive metal plate having a substantially elongated flat plate shape and pressed into a predetermined shape, and bolt through holes 33 are formed at two end portions exposed from the case body 10 and the cover 20.

Various conductive metal materials such as copper, a copper alloy, aluminum, or an aluminum alloy can be used for the conductive metal plate.

As shown in FIG. 2, the case body 10, which is the first member of the present embodiment, includes a bottom wall portion 11 formed in a substantially rectangular shape in a plan view, and two side wall portions 13 vertically provided on two side edges of the bottom wall portion 11 in a left-right width direction.

As shown in FIG. 2, the cover 20, which is the second member of the present embodiment, has an upper wall portion 21 formed in a substantially rectangular shape in a plan view, which is substantially the same as an outer shape of the case body 10, and two side wall portions 23 hanging down from two side edges of the upper wall portion 21.

Further, four case-side locking portions 19 are provided on two side wall portions 13 of the case body 10. Further, the cover 20 is provided with four cover-side locking portions 29 hanging down from the two side edges of the upper wall portion 21 in the left-right width direction.

As shown in FIG. 3, each of the case-side locking portions 19 and each of the cover-side locking portions 29 constitute the lock structure 6 that integrally holds the case body 10 and the cover 20.

As shown in FIGS. 4 to 8, the cover-side locking portion 29 of the present embodiment includes a cantilevered flexible engagement frame 25 extending along an outer surface of the side wall portion 13 of the case body 10, and an engagement piece engaging portion 27 abutting against a tip 13a of the side wall portion 13.

The flexible engagement frame 25 has a pair of hanging portions 25a extending downward from the upper wall portion 21 and a connecting portion 25b connecting tips of the hanging portions 25a, and a substantially rectangular opening is defined by the upper wall portion 21, the hanging portions 25a, and the connecting portion 25b.

As shown in FIGS. 4 and 6, the engagement piece engaging portion 27 is provided between base portions of the two hanging portions 25a on an inner surface 25c of the flexible engagement frame 25. The engagement piece engaging portion 27 is formed in a U-shape in cross section having a restriction wall 26 having a restriction surface 26a that abuts against an inner surface 17a of an engagement piece 17 of the case-side locking portion 19 to be described later, and a pair of support walls 28 erected on two side ends of the restriction wall 26 and respectively connected to the base portions of the pair of hanging portions 25a of the flexible engagement frame 25. Lower end portions 28a of the support walls 28 can position the cover 20 with respect to the case body 10 by abutting against the tips of the side wall portions 13 of the case body 10.

As shown in FIGS. 5 to 8, the case-side locking portion 19 of the present embodiment includes an engagement protrusion 15 protruding from the outer surface of the side wall portion 13 and the engagement piece 17 protruding from the tip 13a of the side wall portion 13.

The engagement protrusion 15 has a lower end locking portion 15a that locks the connecting portion 25b of the flexible engagement frame 25 while the tip of the side wall portion 13 of the case body 10 abuts against the lower end portion 28a of the support wall 28 of the engagement piece engaging portion 27 in the cover 20 to cover the upper opening of the case body 10 by the upper wall portion 21. Further, the engagement protrusion 15 has an inclined surface 15b that is formed from an upper side toward a lower side in a manner of being separated from the outer surface of the side wall portion 13 and bends the flexible engagement frame 25 outward.

When the cover 20 is attached to the case body 10, the flexible engagement frame 25 of the cover-side locking portion 29 is locked to the engagement protrusion 15 of the case-side locking portion 19, and the case-side locking portion 19 and the cover-side locking portion 29 are engaged with and locked to each other.

The engagement piece 17 of the case-side locking portion 19 is a substantially rectangular protrusion piece extending upward from the tip 13a of the side wall portion 13, and has the inner surface 17a continuous with the inner surface of the side wall portion 13 and a tapered surface 17b formed at an upper end edge of the inner surface 17a. A width dimension W2 of the engagement piece 17 is set to be narrower than an interval W3 between the pair of support walls 28 (that is, an opening width of the flexible engagement frame 25) in the engagement piece engaging portion 27 and larger than a width dimension W1 of the engagement protrusion 15.

In a case where the cover 20 is engaged and locked while covering the upper opening of the case body 10, the engagement piece 17 reaches the engagement piece engaging portion 27 along the inner surface 25c of the flexible engagement frame 25. Since the width dimension W2 of the engagement piece 17 larger than the width dimension W1 of the engagement protrusion 15 is narrower than the interval W3 between the pair of support walls 28, as shown in FIGS. 7 and 8, the inner surface 17a of the engagement piece 17 can face and abut against the restriction surface 26a of the restriction wall 26.

Next, an assembly procedure of the conductive member 1 will be described.

First, the intermediate portion of the flat conductor 30 is placed on the bottom wall portion 11 of the case body 10 in an overlapping manner. Two side edge portions of the flat conductor 30 placed on the bottom wall portion 11 are covered with the two side wall portions 13.

Next, the upper wall portion 21 of the cover 20 is placed on the case body 10 in an overlapping manner to cover the upper opening of the case body 10 and hold the flat conductor 30. In this case, the flexible engagement frame 25 of the cover-side locking portion 29 is locked to the engagement protrusion 15 of the case-side locking portion 19. That is, the connecting portion 25b of the flexible engagement frame 25 is locked to the lower end locking portion 15a of the engagement protrusion 15.

The protector 5 including the case body 10 and the cover 20 that are disposed to face front and back surfaces of the flat conductor 30 and cover the flat conductor 30 from a plate thickness direction is integrally held by the lock structures 6 including the cover-side locking portions 29 and the case-side locking portions 19.

Next, an operation of the configuration described above will be described.

In the lock structure 6 according to the present embodiment, when the engagement piece 17 reaches the engagement piece engaging portion 27 along the inner surface 25c of the flexible engagement frame 25 in the case where the cover 20 is engaged and locked while covering the upper opening of the case body 10, the inner surface 17a of the engagement piece 17 faces the restriction surface 26a of the restriction wall 26 as shown in FIG. 8.

According to the lock structure 6 of the present embodiment, when the cover 20 rattles along a width direction Y, the inner surface 17a of the engagement pieces 17 protruding from each of the two side wall portions 13 of the case body 10 abuts against the restriction surface 26a of the restriction wall 26 in the engagement piece engaging portion 27 provided on each of the two side edges of the cover 20, and the flexible engagement frame 25 can be prevented from rattling in the width direction Y.

Therefore, the lock structure 6 of the present embodiment can prevent the flexible engagement frame 25 from rattling in the width direction Y and prevent inadvertent unlocking.

Further, in the lock structure 6 according to the present embodiment, the engagement piece engaging portion 27 is formed in a U-shape in cross section including the restriction wall 26 having the restriction surface 26a and the pair of support walls 28 erected on the two side ends of the restriction wall 26 and connected to the base portions of the flexible engagement frame 25.

Therefore, if the cover 20 is displaced along a longitudinal direction X when the upper opening of the case body 10 is covered with the cover 20 and the lock structure 6 is engaged and locked, a side edge of the engagement piece 17 protruding from each of the two side wall portions 13 of the case body 10 abuts against the support walls 28 of the engagement piece engaging portion 27 provided on the side edge of the cover 20, and the flexible engagement frame 25 can be prevented from displacing along the longitudinal direction X.

Therefore, according to the lock structure 6 of the present embodiment, it is unnecessary to set a positioning structure in the longitudinal direction of the cover 20 at another place, the lock structure 6 can be directly positioned, and assemblability of the lock structure 6 is improved.

Further, in the lock structure 6 according to the present embodiment, the width dimension W2 of the engagement piece 17 is set to be narrower than the interval W3 between the pair of support walls 28 and larger than the width dimension W1 of the engagement protrusion 15.

Therefore, the flexible engagement frame 25 can be reliably prevented from displacing along the longitudinal direction X by the engagement piece 17 without increasing the width dimension W1 of the engagement protrusion 15.

Therefore, according to the lock structure 6 according to the present embodiment, inadvertent unlocking can be prevented.

The present disclosure is not limited to the embodiment described above, and can be appropriately modified, improved, or the like. In addition, the materials, shapes, sizes, numbers, arrangement positions, and the like of the components in the embodiments described above are freely selected and are not limited as long as the present disclosure can be implemented.

Here, features of the embodiments of the lock structure according to the present disclosure described above are briefly summarized and listed in the following [1] to [3]. [1] A lock structure (6) including:
an engagement protrusion (15) that protrudes from an outer surface of a side wall portion (13) of a first member (case body 10);
a cantilevered flexible engagement frame (25) that is provided on a side end of a second member (cover 20) fixed to the first member (case body 10) and extends along the outer surface of the side wall portion (13) to engage with the engagement protrusion (15);
an engagement piece (17) that protrudes from a tip (13a) of the side wall portion (13); and
an engagement piece engaging portion (27) that is provided between base portions on an inner surface (25c) of the flexible engagement frame (25) to abut against the tip (13a) of the side wall portion (13), and includes a restriction surface (26a) abutting against an inner surface (17a) of an engagement piece (17) and configured to prevent rattling of the flexible engagement frame (25).

According to the lock structure (6) according to [1] above, when the first member (case body 10) and the second member (cover 20) are engaged and locked, the inner surface (17a) of the engagement piece (17) faces the restriction surface (26a) of the engagement piece engaging portion (27). Then, when the second member (cover 20) rattles along a width direction (Y), the inner surface (17a) of the engagement piece (17) protruding from each of two side wall portions (13) of the first member (the case body 10) abuts against the restriction surface (26a) of the engagement piece engaging portion (27) provided on each of the two side edges of the second member (cover 20), and the flexible engagement frame (25) can be prevented from rattling in the width direction (Y).
[2] The lock structure (6) according to [1] above, in which
the engagement piece engaging portion (27) is formed in a U-shape in cross section that includes a restriction wall (26) having a restriction surface (26a) and a pair of support walls (28) erected on two side ends of the restriction wall (26) and connected to the base portions of the flexible engagement frame (25).

According to the lock structure (6) described in [2] above, if the second member (cover 20) is displaced along the longitudinal direction (X) when the first member (case body 10) and the second member (cover 20) are engaged and locked, a side edge of the engagement piece (17) protruding from the side wall portion (13) of the first member (case body 10) abuts against the support walls (28) of the engagement piece engaging portion (27) provided on the side edge of the second member (cover 20), and the flexible engagement frame (25) can be prevented from displacing along the longitudinal direction (X).

Therefore, it is unnecessary to set a positioning structure in the longitudinal direction of the second member (cover 20) at another place, and the lock structure (6) can be directly positioned, and assemblability of the lock structure (6) is improved.
[3] The lock structure (6) according to [2] above, in which
a width dimension (W2) of the engagement piece (17) is smaller than an interval (W3) between the pair of support walls (28) and larger than a width dimension (W1) of the engagement protrusion (15).

According to the lock structure (6) according to [3] above, the flexible engagement frame (25) can be reliably prevented from displacing along the longitudinal direction (X) by the engagement piece (17) without increasing the width dimension (W1) of the engagement protrusion (15).

1. A lock structure comprising:
an engagement protrusion that protrudes from an outer surface of a side wall portion of a first member;
a cantilevered flexible engagement frame that is provided on a side end of a second member fixed to the first member and extends along the outer surface of the side wall portion to engage with the engagement protrusion;
an engagement piece that protrudes from a tip of the side wall portion; and
an engagement piece engaging portion that is provided between base portions on an inner surface of the flexible engagement frame to abut against the tip of the side wall portion, and includes a restriction surface abutting against an inner surface of an engagement piece and configured to prevent rattling of the flexible engagement frame.

2. The lock structure according to claim 1, wherein
the engagement piece engaging portion is formed in a U-shape in cross section that includes a restriction wall having a restriction surface and a pair of support walls erected on two side ends of the restriction wall and connected to the base portions of the flexible engagement frame.

3. The lock structure according to claim 2, wherein
a width dimension of the engagement piece is smaller than an interval between the pair of support walls and larger than a width dimension of the engagement protrusion.
